(19) United States
(12) Patent Application Publication
(10) Pub. No.: US 2021/0241743 A1
(43) Pub. Date: Aug. 5, 2021

(54) PORTABLE SOUND-REDUCING ENCLOSURE FOR POWER EQUIPMENT

(71) Applicant: Stoyan Kirilov STOYANOV, Saulnierville (CA)

(72) Inventor: Stoyan Kirilov STOYANOV, Saulnierville (CA)

(73) Assignee: Foamtech North America Ltd., Sidney (CA)

(21) Appl. No.: 17/166,559

(22) Filed: Feb. 3, 2021

(30) Foreign Application Priority Data
Feb. 5, 2020 (CA) 3070843

(51) Int. Cl. G10K 11/162

(52) U.S. Cl. CPC G10K 11/162

(57) ABSTRACT

A portable sound-reducing enclosure including a panel structure having a plurality of panels. The panel structure is adapted for surrounding sides and a top of a power equipment. The panels include a sound-absorbing material such that the enclosure is capable of substantially reducing sound emitted from the power equipment.

This application claims priority to Canadian Patent Application No. 3,070,843 filed on Feb. 5, 2020 and entitled Portable Sound-Reducing Enclosure For Power Equipment, the entire contents of which are hereby incorporated by reference.

### FIELD

The present disclosure relates to protective covers for power equipment, and more particularly to a portable enclosure surrounding the power equipment for protecting the same from adverse weather conditions as well as for substantially reducing the sound emitted from the power equipment.

### BACKGROUND

Various types of small and medium sized power equipment with diesel, electric, or gas engines such as, for example, water pumps, generators, and compressors are frequently used in industrial and construction sites.

Currently, protective covers for power equipment are provided by the power equipment manufacturer as welded steel sheets cut to size to fit a specific type of power equipment which are then, typically, mounted to the power equipment.

Unfortunately, these protective covers are heavy and expensive to manufacture. Furthermore, the power equipment under the fixed protective cover is hard to access and, therefore, regular maintenance work can be a difficult task in the field, frequently requiring shipment of the power equipment to a mechanical shop for maintenance or repair. As a result, many companies buy the power equipment without protective covers, thus exposing the power equipment to adverse weather conditions and, furthermore, exposing workers and possibly the public to unsafe levels of noise.

It is noted that in most urban areas government regulations limit the emission of noise above a, what is considered, safe noise level of, typically, 69 dB, thus prohibiting the use of this kind of power equipment without substantial sound protection.

It may be desirable to provide an enclosure for power equipment that is capable of substantially reducing the sound emitted from the power equipment.

It also may be desirable to provide an enclosure for power equipment that is cost-effective to manufacture.

It also may be desirable to provide an enclosure for power equipment that is easily adaptable for covering different types of power equipment.

It also may be desirable to provide an enclosure for power equipment that is light-weight and portable.

It also may be desirable to provide an enclosure for power equipment that is easily and fast assembled and disassembled.

### SUMMARY

Accordingly, in one embodiment the present invention provides an enclosure for power equipment that is capable of substantially reducing the sound emitted from the power equipment.

The present invention can provide an enclosure for power equipment that is cost-effective to manufacture.

The present invention can provide an enclosure for power equipment that is easily adaptable for covering different types of power equipment.

The present invention can provide an enclosure for power equipment that is light-weight and portable.

The present invention can provide an enclosure for power equipment that is easily and fast assembled and disassembled.

According to one aspect of the present invention, there is provided a portable sound-reducing enclosure. The portable sound-reducing enclosure comprises a panel structure having a plurality of panels. The panel structure is adapted for surrounding sides and a top of a power equipment. The panels comprise a sound-absorbing material such that the enclosure is capable of substantially reducing sound emitted from the power equipment.

According to another aspect of the present invention, there is provided a portable sound-reducing enclosure. The portable sound-reducing enclosure comprises a panel structure having a plurality of panels. The panel structure is adapted for surrounding sides and a top of a power equipment. The panels comprise a sound-absorbing material such that the enclosure is capable of substantially reducing sound emitted from the power equipment. The panel structure comprises at least two parts adapted for being connected to each other to form the enclosure.

According an aspect of the present invention, there is provided a portable sound-reducing enclosure. The portable sound-reducing enclosure comprises a panel structure having a plurality of panels. The panel structure is adapted for surrounding sides and a top of a power equipment. The panels comprise a sound-absorbing material such that the enclosure is capable of substantially reducing sound emitted from the power equipment. The panels are made of aluminum foam.

An advantage of the present invention is that it provides an enclosure for power equipment that is capable of substantially reducing the sound emitted from the power equipment.

A further advantage of the present invention is that it provides an enclosure for power equipment that is cost-effective to manufacture.

A further advantage of the present invention is that it provides an enclosure for power equipment that is easily adaptable for covering different types of power equipment.

A further advantage of the present invention is that it provides an enclosure for power equipment that is light-weight and portable.

A further advantage of the present invention is that it provides an enclosure for power equipment that is easily and fast assembled and disassembled.

### BRIEF DESCRIPTION OF THE DRAWINGS

An embodiment of the present invention is described below with reference to the accompanying drawings, in which:

FIG. 1 is a simplified block diagram illustrating in a perspective view a portable sound-reducing enclosure for power equipment according to an embodiment of the invention;

FIG. 2 is a simplified block diagram illustrating in a perspective view components of the portable sound-reducing enclosure for power equipment according to an embodiment of the invention;

FIG. 3 is a simplified block diagram illustrating in a front view installation of the portable sound-reducing enclosure for power equipment according to an embodiment of the invention;

FIG. 4 is a simplified block diagram illustrating in a front view installation of the portable sound-reducing enclosure for power equipment according to an embodiment of the invention;

FIG. 5 is a simplified block diagram illustrating in a front view installation of the portable sound-reducing enclosure for power equipment according to an embodiment of the invention;

FIG. 6 is a simplified block diagram illustrating in a front view flaps for covering an opening of the portable sound-reducing enclosure for power equipment according to an embodiment of the invention;

FIG. 7 is a simplified block diagram illustrating in front view an implementation for providing an opening in the panels of the portable sound-reducing enclosure for power equipment according to an embodiment of the invention;

FIG. 8 is a simplified block diagram illustrating in front view an implementation for providing an opening in the panels of the portable sound-reducing enclosure for power equipment according to an embodiment of the invention;

FIG. 9 is a simplified block diagram illustrating in a cross-sectional view a louver with baffles of the portable sound-reducing enclosure for power equipment according to an embodiment of the invention;

FIG. 10 is a simplified block diagram illustrating in a side view a panel of the portable sound-reducing enclosure for power equipment according to an embodiment of the invention;

FIG. 11 is a simplified block diagram illustrating in a perspective view a frame structure of the portable sound-reducing enclosure for power equipment according to an embodiment of the invention; and,

FIG. 12 is a simplified block diagram illustrating in a perspective view a an upper corner of the portable sound-reducing enclosure for power equipment according to an embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to a sound-reducing enclosure for covering a medium sized pump mounted to a base for being placed onto ground, it will become evident to those skilled in the art that the embodiments of the invention are not limited thereto, but are also adaptable for covering various other types of power equipment such as, for example, generators and compressors of various size, as well as, for covering power equipment mounted to a trailer.

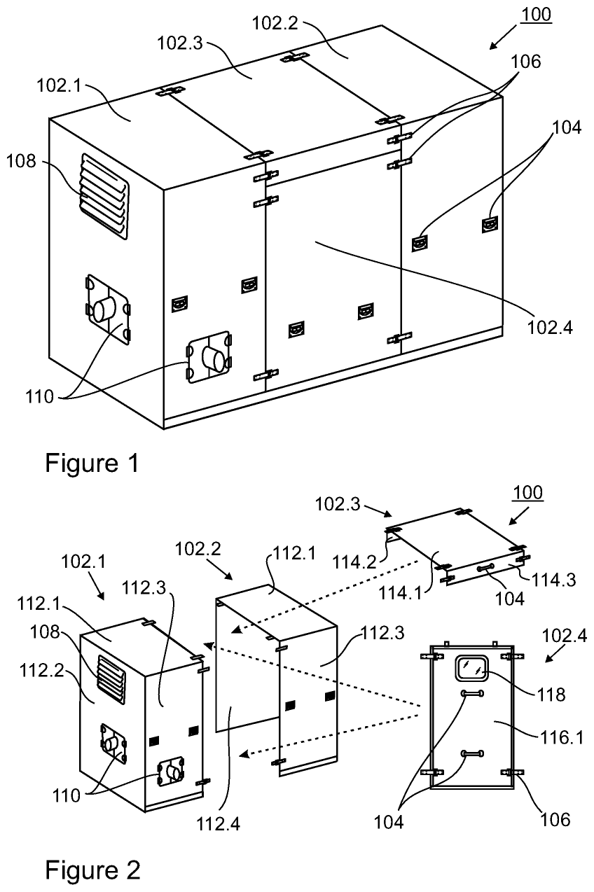

Referring to FIGS. 1 to 12 a portable sound-reducing enclosure for power equipment 100 according to an embodiment of the invention is provided. The enclosure 100 comprises a panel structure having a plurality of panels for surrounding sides and a top of a power equipment 20, as illustrated in FIGS. 1 to 5. The panels comprise a sound-absorbing material such that the enclosure is capable of substantially reducing sound emitted from the power equipment, as will be described in detail hereinbelow. The enclosure 100 can comprises two or more parts in order to facilitate transport, handling, and installation. For example, the enclosure is divided into two end parts 102.1, 102.2 and three parts 102.3, 102.4 forming a mid-section. Each end part 102.1, 102.2 is made of four panels 112.1 to 112.4 forming three sides and a top. The mid-section part 102.3 is made of three panels 114.1 to 114.3 forming a top and two downward facing sides. The two mid-section parts 102.4 are made of a single panel 116.1.

It is noted that the division of the enclosure 100 into the parts as described hereinabove is not limited thereto, but one skilled in the art will readily arrive at different divisions with different numbers and shapes of parts depending on the size and shape of the power equipment to be covered.

The enclosure 100 comprises openings 110 for enabling placement of conduits therethrough such as, for example, an intake hose and a discharge hose of a pump, which are placed depending on the design of the power equipment, for example, in the panels 112.2 and 112.3 of the end part 102.1, as illustrated in FIGS. 1 and 2. The enclosure 100 further comprises one or more louvers 108 for ventilating the enclosed space. To enable the operator to see and/or access controls of the power equipment 20 without having to remove the enclosure or parts thereof, the enclosure 100, in one case, comprises one or more observation windows and/or access doors 118.

In order to facilitate handling and to enable quick assembly/disassembly, each of the parts 102.1 to 102.4, can have grab handles 104 and adjustable latches 106 mounted thereto. Use of the adjustable latches 106 enable quick assembly/disassembly of the enclosure 100. Alternatively, the parts 102.1 to 102.4 may be connected using different fasteners such as, for example, screw bolts.

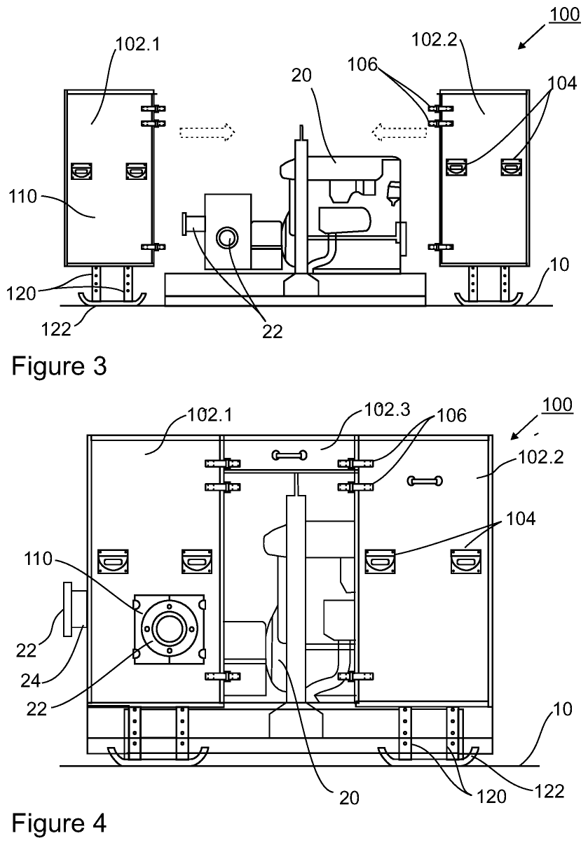

For assembly, first the end parts 102.1 and 102.2 are placed such that they cover end portions of the power equipment 20, as indicated by the block arrows in FIG. 3. The mid-section part 102.3 is then placed between the end parts 102.1 and 102.2 and secured thereto using the adjustable latches 106, as illustrated in FIG. 4. For example, the end parts 102.1 and 102.2 are directly placed on ground 10. Alternatively, the end parts 102.1 and 102.2 comprise height adjustable legs 120 mounted to a bottom end thereof in order to facilitate assembly, in particular, on uneven ground 10. For example, the legs 120 comprise a conventional screw mechanism for enabling the height adjustment. Further optionally, skids 122 or wheels are mounted to the legs 120 in order to facilitate handling and placing of the end parts 102.1 and 102.2. After assembly of the enclosure 100 a skirt 124 made of a flexible material such as, for example, a rubber material, may be attached in a conventional manner using, for example, snap fasteners, to the bottom end of the enclosure 100 to cover the gap between the bottom end of the enclosure 100 and the ground 10. In case the power equipment 20 comprises a combustion engine, a flex hose is attached to the engine exhaust pipe at a first end thereof using, for example, a conventional quick clamp and a second end is placed at the lower part of the enclosure 100 or, alternatively, is connected to a conventional through hull fitting disposed in one of the panels.

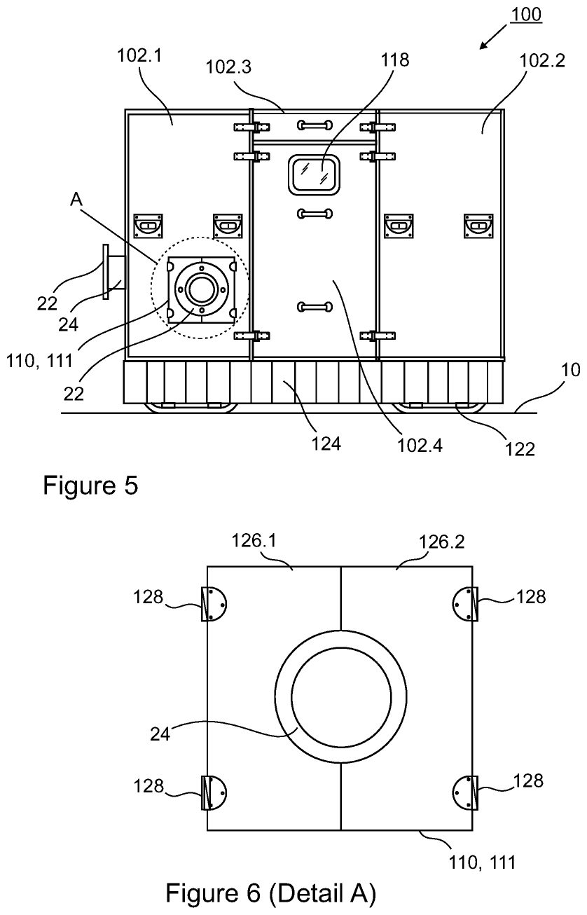

Medium sized pumps, typically, have pipes 24 with connecting flanges 22 for being connected to intake and discharge conduits, as illustrated in FIGS. 4 and 5. In order to enable installation of the enclosure 100, the openings 110 are designed such that the flanges 22, having a larger cross-section than the pipes 24, can be fitted therethrough when placing the respective part of the enclosure 100. The area between the pipe 24 and a panel edge 111 surrounding the opening 110 can be covered by providing two flaps 126.1, 126.2 that are pivotally movable mounted to the respective panel 112 in a conventional manner using, for example, hinges 128, as illustrated in FIG. 6. During installation, the flaps 126.1, 126.2 are in an open position enabling passage of the connecting flange 22 through the opening 110 and after placement of the enclosure 100 the flaps are moved in a closed position in order to substantially prevent transmission of sound therethrough. The flaps 126.1, 126.2 are made of, for example, the same material as the panels 112 as will be described in detail hereinbelow. For pumps without connecting flanges 22, typically smaller pumps, the openings 110 are provided having circular cross-section with a diameter that is slightly larger than the outside diameter of a hose for being connected to the pump, enabling passage of the same therethrough. For example, for a 4 inch outside diameter hose the diameter of the opening 110 is 5 inches.

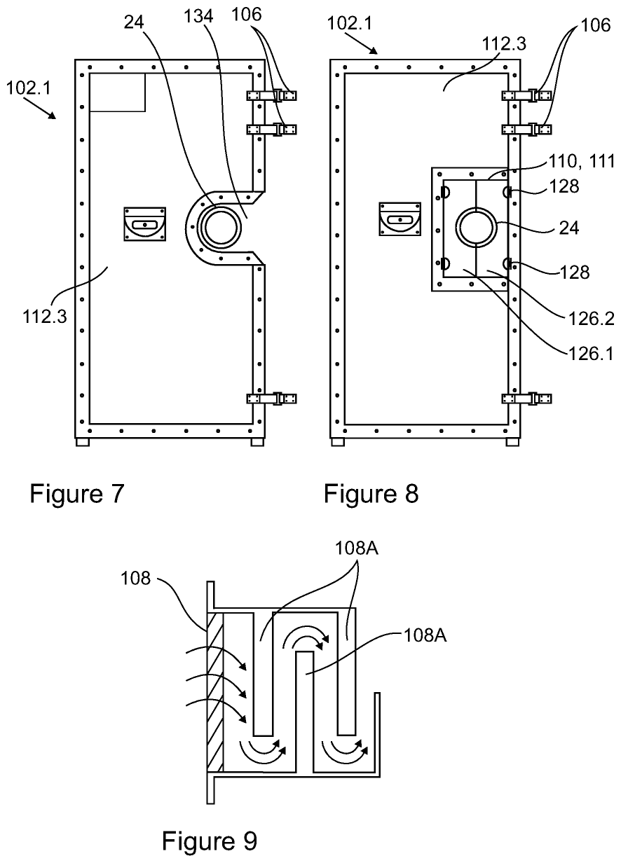

Optionally, the opening may be provided as a cut-out 134, as illustrated in FIG. 7, instead of an opening 110, as illustrated in FIG. 8.

For use of the enclosure 100 with very noisy power equipment, the louver 108, can have a sound-reducing structure made of, for example, baffles 108A attached to an inside thereof, as illustrated in FIG. 9. The baffles 108A enable airflow therethrough, as indicated by the arrows in FIG. 9, while substantially preventing transmission of sound.

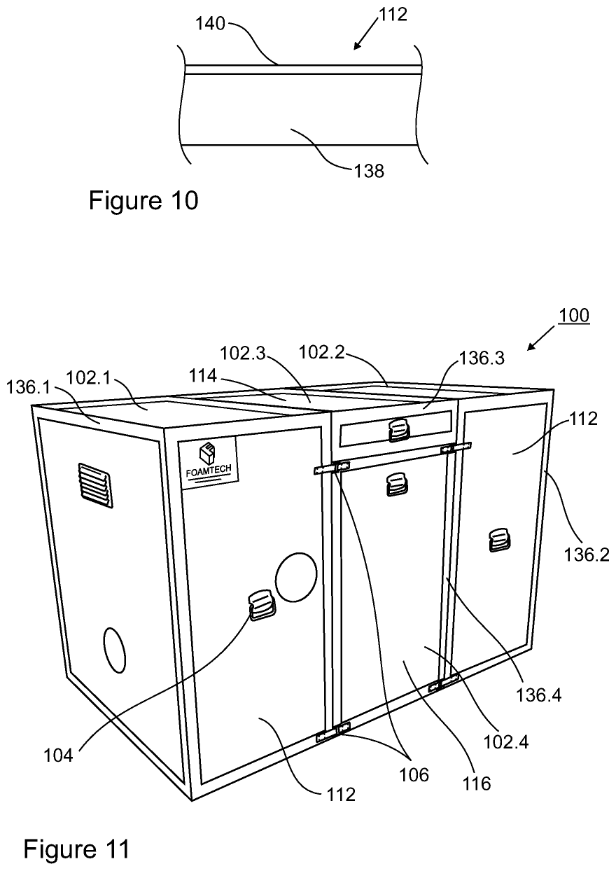

The panels 112, 114, 116 of the enclosure 100 can be made of aluminum foam. Aluminum foam is light weight with a density that is approximately 1/10 of the density of aluminum, is sound absorbing with a sound absorption coefficient of 0.65 NRC, has substantial stiffness and strength under extreme shock, and is non-flammable. The thermal conductivity of Alufoam is 0.268 W/mK, thus providing substantial protection in case of fire. As illustrated in FIG. 10, an exterior cover sheet 140 which can be made of, for example, fiberglass or thin sheet aluminum, is directly bonded to the aluminum foam 138 using a suitable adhesive such as, for example, a resin or epoxy glue, providing a smooth outer surface for impact and weather protection. In example implementations of the enclosure 100, the panels 112, 114, 116 were made of aluminum foam 138 having a thickness of 12 mm with an exterior cover sheet 140 made of fiberglass having a thickness of 1.5 mm or made of thin sheet aluminum having a thickness of 1.0 mm to 1.2 mm. The resulting enclosure parts 102.1 to 102.4 are light weight but have substantial stiffness and strength, thus enabling easy handling during assembly/disassembly. Furthermore, the example implementations of the enclosure 100 provide substantial noise reduction of approximately 30 dB.

Alternatively, the panels 112, 114, 116 may be made of acoustic panels bonded to composites, metal, or fiber glass panels. Further alternatively, the exterior cover sheet 140 may be replaced by an exterior coating such as, for example, a suitable paint. Yet further alternatively, the panels may be made of aluminum sheet material combined with, for example, a non-flammable urethane foam material disposed on the inside for sound absorption.

As illustrated in FIG. 11, the enclosure parts 102.1, 102.2, 102.3, 102.4 can each comprise a metal frame structure 136.1, 136.2, 136.3, 136.4, respectively, having the panels mounted thereto in a conventional manner using, for example, screw fasteners. The metal frame structure is made of, for example, aluminum or steel angle profiles. Using a metal frame structure 136 having the panels mounted thereto using screw fasteners enables easy adaptation to a different piece of power equipment having, for example, intake and discharge conduits at different locations by changing the panels where the conduits are located.

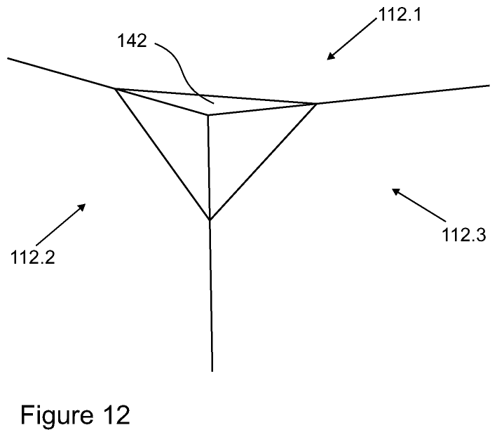

Alternatively, the panels are directly bonded together using a suitable industrial glue with corner guards 142 made of, for example, aluminum or steel sheet material bonded to the upper corners of the enclosure 100, as illustrated in FIG. 12.

The present invention has been described herein with regard to certain embodiments. However, it will be obvious to persons skilled in the art that a number of variations and modifications can be made without departing from the scope of the invention as described herein.

What is claimed is:

1. A portable sound-reducing enclosure comprising a panel structure having a plurality of panels, the panel structure being adapted for surrounding sides and a top of a power equipment, wherein the panels comprise a sound-absorbing material such that the enclosure is capable of substantially reducing sound emitted from the power equipment.

2. The enclosure according to claim 1 wherein the panel structure comprises at least two parts adapted for being connected to each other to form the enclosure.

3. The enclosure according to claim 1 comprising a frame having the panels mounted thereto.

4. The enclosure according to claim 1 wherein the panels are made of a metal foam material.

5. The enclosure according to claim 4 wherein the panels are made of aluminum foam.

6. The enclosure according to claim 4 wherein the panels comprise an exterior cover sheet adhered to the metal foam material.

7. The enclosure according to claim 6 wherein the exterior cover sheet comprises one of thin sheet aluminum and fiberglass.

8. The enclosure according to claim 1 comprising latches for connecting the at least two parts.

9. The enclosure according to claim 1 comprising at least a louver disposed in at least one of the panels, the louver having a baffle structure mounted thereto for reducing transmission of sound therethrough.

10. The enclosure according to claim 1 comprising at least an opening disposed in at least one of the panels.

11. The enclosure according to claim 10 wherein the at least an opening is adapted for enabling passage of a conduit connected to the power equipment through the panel.

12. The enclosure according to claim 11 comprising flaps for substantially covering an area of the opening between the conduit and the panel, the flaps being pivotally movable mounted to the panel.

13. The enclosure according to claim 1 comprising height adjustable legs mounted to a bottom end of the enclosure.

14. The enclosure according to claim 13 comprising a skirt made of a flexible material mounted to a bottom end of the enclosure.

15. The enclosure according to claim 1 comprising a through hull fitting disposed in one of the panels, the through hull fitting for enabling emission of exhaust gas from the power equipment.

16. The enclosure according to claim 1 wherein each of the at least two parts comprises handles.
